(19) United States
(12) Patent Application Publication
(10) Pub. No.: US 2010/0238462 A1
(43) Pub. Date: Sep. 23, 2010

(54) SYSTEM AND METHOD FOR IMAGE QUALITY ANALYSIS AND DIAGNOSTICS

(75) Inventors: Jeremy Lee Reitz, Marion, NY (US); Yevgeniy Shustef, Macedon, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/405,782

(22) Filed: Mar. 17, 2009

(51) Int. Cl. H04N 1/60; G06F 3/12

(52) U.S. Cl. 358/1.9; 358/1.15

(57) ABSTRACT

A system and method for diagnosing image quality of a printer device's output is provided. The method includes receiving by a processor, via a network from a remote node of the network, a service incident report. The incident report includes an indication of a type of the printer device the printer device being disposed along the network at a location remote from the processor. The method further includes accessing by the processor a storage device storing a collection of test patterns, selecting by the processor a test pattern from the collection of test patterns based on the type of the printer device, wherein the test pattern is configured as input that the printer device can receive and output corresponding printed output, and transmitting by the processor the selected test pattern for the selected test pattern to be provided as input to the printer device.

### BACKGROUND

The present disclosure relates generally to image analysis of printer output and corresponding diagnostics of printer devices. In particular, the present disclosure relates to image analysis of printer output and corresponding diagnostics of printer devices from a remote location.

A printer user may notice that documents output by a printer device are defective, and conclude that the printer device is malfunctioning and needs to be serviced. The maintenance and repair service provider will want to know the nature of the problem before it dispatches a technician to the printer device site for analyzing and diagnosing the problem and determining if it is necessary to order parts or supplies. However, the service provider relies on the user's verbal description of the problem to understand the nature of the problem. The user may not know to look for or notice particular defects in the image on the defective document which will be useful in diagnosing the problem. Furthermore, while the user may recognize that something is wrong with the image, the image itself may not show enough information for diagnosing the problem.

### SUMMARY

The present disclosure is directed to an image quality diagnostic system for diagnosing an image output by a printer device. The system includes at least one processor device communicating with a network for executing a series of programmable instructions for performing a method. The method includes receiving via the network from a remote node of the network a service incident report. The service report includes an indication of a type of a printer device, the printer device being disposed along the network at a location remote from the at least one processor device. The method further includes accessing a storage device storing a collection of test patterns, electronically selecting a test pattern from the collection of test patterns based on the type of the printer device, wherein the test pattern is configured as input that the printer device can receive and output corresponding printed output, and transmitting the selected test pattern via the network for the selected test pattern to be provided as input to the printer device.

The present disclosure is also directed to an image quality diagnostic system for diagnosing an image output by a printer device. The system includes at least one processor device communicating with a network for executing a series of programmable instructions for performing a method. The method includes receiving via the network from a remote node of the network an image of printed output output by a printer device, wherein the printed output corresponds to an input test pattern. Additionally, the method includes electronically selecting a set of at least one rule from a plurality of rules based on a type of the printer device, electronically analyzing the image for detecting a defect in the image by applying the selected set of at least one rule, electronically generating at least one recommendation for servicing the printer device based on the detected defect by applying the selected set of at least one rule, and outputting the at least one recommendation.

The present disclosure is also directed to a method for diagnosing image quality of a printer device's output. The method includes receiving by a processor, via a network from a remote node of the network, a service incident report. The incident report includes an indication of a type of the printer device the printer device being disposed along the network at a location remote from the processor. The method further includes accessing by the processor a storage device storing a collection of test patterns, selecting by the processor a test pattern from the collection of test patterns based on the type of the printer device, wherein the test pattern is configured as input that the printer device can receive and output corresponding printed output, and transmitting by the processor the selected test pattern for the selected test pattern to be provided as input to the printer device.

The present disclosure is further directed to a computer-readable medium storing a series of programmable instructions configured for execution by at least one processor for performing a method for diagnosing image quality. The method includes the steps of receiving a service incident report, wherein the service incident report includes an indication of a type of a printer device. The method further includes the steps of accessing a storage device storing a collection of test patterns, and selecting a test pattern from the collection of test patterns based on the type of the printer device, wherein the test pattern is configured as input that the printer device can receive and output corresponding printed output. Additionally, the method includes the steps of transmitting the selected test pattern for the selected test pattern to be provided as input to the printer device, receiving an image of printed output, wherein the printed output corresponds to the selected test pattern, and analyzing the image for detecting a defect in the image. The method finally includes the steps of generating at least one recommendation for servicing the printer device based on the detected defect, and outputting the at least one recommendation.

Other features of the presently disclosed image quality diagnostic system will become apparent from the following detailed description, taken in conjunction with the accompanying drawings, which illustrate, by way of example, the presently disclosed image quality diagnostic system.

### BRIEF DESCRIPTION OF THE DRAWINGS

Various embodiments of the present disclosure will be described below with reference to the figures, wherein:

FIG. 1 is a block diagram of an exemplary image quality diagnostic system in accordance with the present disclosure;

FIG. 2 is a flowchart of a diagnostic routine overseen by a human operator operated service desk and performed by the system shown in FIG. 1; and

FIG. 3 is a flowchart of a diagnostic routine automatically performed by the system shown in FIG. 1.

### DETAILED DESCRIPTION

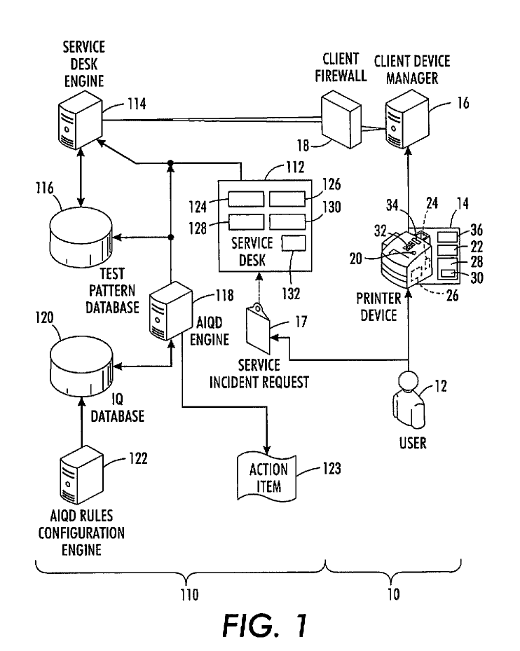

Referring now to the drawing figures, in which like references numerals identify identical or corresponding elements, the remote image quality diagnostics system and method in accordance with the present disclosure will now be described in detail. With initial reference to FIG. 1, an exemplary image quality diagnostics (IQD) system in accordance with the present disclosure is illustrated and is designated generally as IQD system 100. IQD system 100 includes a client side 10 and a server side 110. On the client side, a user 12 operates at least one printer device 14. Each printer device 14 may be in digital communication with a client device manager 16. The client device manager 16 communicates digitally with the service provider side 110, e.g., with a firewall disposed on the client side 10 and/or the service provider side 110. In the present example a client firewall 18 is provided.

The printer device 14 may be a multi-function device having functionality in addition to printing, such as faxing and scanning. The term “printer device” as used herein encompasses any apparatus or system, such as a digital copier, xerographic printing system, ink jet printing system, reprographic printing system, bookmaking machine, facsimile machine, multifunction machine, textile marking machine, etc., which performs a marking output function for any purpose. The modality for marking may include, for example, applying toner, ink, dye, etc., to the substrate or embossing, peening, etching, etc. the substrate. The substrate may be a material such as paper, cardboard, a transparency, a paper derivative, metal, plastic, glass, wood, cloth, etc.

The printer device 14 may be provided with an input device 20 which is actuated when it is detected that an incident has occurred, where the incident includes the printer device 14 outputting a defective image. The input device 20 may be actuated by the user 12 when the user wishes to alert the service provider side 110 that an incident has been detected. The input device 20 may be a mechanical and/or electronic switch located on the printer device 14 that the user actuates, such as via a push button, swiping a card with a magnetic strip, etc. The input device 20 may be configured so that it can be actuated from a remote location by a user or a remote processor.

The printer device 14 is provided with a communication module 22 which includes hardware and software for enabling the printer device to communicate electronically with another processor, such as the client device manager 16, for receiving instructions or print jobs. Additionally, the communication module 22 may be capable of communication via a network. This network communication may include the ability to transmit and receive data with another device, such as for receiving print jobs and transmitting output data. The output data may include status data indicating the status of a printing job, and may further include content data, such as data file corresponding to a scanned document. The network may be, for example, a LAN, WAN, intranet or the Internet. Accordingly, the network communication may include the ability to browse on the Internet, communicate with other devices, e.g., via email, send a data file, e.g., a scanned document, to a selected destination, e.g., as an email attachment.

As mentioned above, the printer device 14 may be a multi-function device (MFD)that is provided with a scanner device 24 that captures an image of a document and generates data that corresponds to the image. The scanner device 24 may include a glass plate or platen upon which the document being imaged is positioned for imaging thereof. The printer device 14 may further be provided with a transport device 26 that transports a printed document output by the printer device 14 to the platen of the scanner device 24 for scanning of the printed output document.

The printer device 14 is provided with a processor 28 that executes a software module 30. The software module 30 at least controls the printer device 14 and its components to perform and synchronize the tasks performed by the various components. The printer device 14 is provided with a UI 32 (e.g., a keypad) and/or GUI 34 (e.g., a display screen) by which user 12 may input information to the processor 28 and receive output from the processor 28. Input device 20 may be integrated with the UI 32. The UI 32 and GUI 32 may be provided on a control panel 36 of the printer device 14. Additionally, the printer device 14 includes a printer engine 36 which marks a substrate in accordance with a printing operation.

The client device manager 16 includes a processor 38, a software module 40 executable on the processor 38, and a communication device 42 for communicating digitally with another processor, e.g., via a network. The client device manager 16 may communicate digitally with one or more printer devices 14 and handle communication between the printer devices 14 and the service provider side 110, such as by acting as an interface for communication between the printer device 14 and the service provider side 110. Each message that the any of the printer devices 14 connected to the client device manager 16 transmits to the service provider side I 10 is transmitted to the client device manager 16. The client device manager 16 then transmits the message to the service provider side 110. Likewise, each message from the service provider side 110 that is transmitted to a printer device 14 on the client side 10 is transmitted via the client device manager 16. The client device manager 16 receives the message from the service provider side 110 and provides the message to the appropriate printer device 14 targeted in the message. Each printer device 14 has an associated identification (ID) code that identifies the printer device 14. The printer ID code may be included in messages sent by the printer device 14 for identifying the sender. The printer ID code may further be included in messages sent to the printer device 14 for identifying the printer device 14 that is the intended recipient.

In one embodiment, the printer device 14 is capable of communicating independently with the service provider side 110. In this embodiment, the client device manager 16 may be omitted for the purposes of providing a communication interface between the printer device 14 and the service provider side 110.

The client firewall 18 may include firewall software and/or hardware for maintaining a secure environment on the client side and only allowing appropriate messages to be transmitted from the service provider side 110 to the client device manager 16. Firewall software and hardware is well known in the art. As mentioned above, the service provider side 110 may include a firewall as well for providing a secure environment on its side.

The service provider side 110 includes a service desk 112 operated by an operator which receives a request 17 to file a service incident report from the client side 10, generates the service incident report and transmits it via data communication to a service desk engine 114 which further processes the service incident report and stores it in a test pattern database 116.

Alternatively, the service desk engine 114 may receive the service incident report directly from the client side 10. The service provider side 110 further includes an analysis and image quality definition (AIQD) engine 118 which accesses an image quality (IQ) database 120 and uses information retrieved from the IQ database 120 to further processes the service incident report and generate a solution. An AIQD rules configuration engine 122 is further provided on the service provider side 110 for processing image quality data and generating AIQD rules that are stored in the IQ database 120.

Each of the service desk engine 114, the AIQD engine 118, and the AIQD rules configuration engine 122 includes a respective processor and a software module executable by the processor. Furthermore, each of the service desk engine 114, the AIQD engine 118, and the AIQD rules configuration engine 122 includes a communication module including any necessary hardware and/or software for enabling the processor of the associated engine to communicate with another processor or to access a database in accordance with the functions described throughout.

Additionally, the test pattern database 116 is accessible by the processor(s) executing the software modules associated with the service desk engine 114 and the AIQD engine 118. The IQ database 120 is accessible by the processor(s) executing the software modules associated with the AIQD engine 118 and the AIQD rules configuration engine 122. The test pattern database 116 and the IQ database 120 each include hardware and software for storing, accessing and retrieving from a collection of at least one test pattern.

Any combination of the service desk engine 114, test pattern database 116, AIQD engine 118, IQ database 120 and the AIQD rules configuration engine 122 may be integrated into a single unit, e.g., that is housed within a single housing and/or share one or more resources including their processor(s). Alternatively, any combination of the service desk engine 114, test pattern database 116, AIQD engine 118, IQ database 120 and the AIQD rules configuration engine 122 may be remote from one another. The remote devices may communicate with one another via a bus, wired or wireless communication device, and/or a network, such as a LAN, WAN, intranet or the Internet.

The test patterns stored in the test pattern database 116 include printer ready files that may be input to a printer, such as printer device 14, and a request to print the printer ready file. Upon receiving the test pattern, the printer prints the test pattern. The test pattern's printer ready file includes data to be printed and instructions in how it should be printed, e.g., how it is to be laid out and formatted for producing one or more images that are printed on a substrate. The printer ready files are configured to require the printer device 14 utilize various components of its print engine to produce the image(s) so that the image(s) produced will indicate if a component has a defect.

Each test pattern is designed for a particular printer for testing the particular hardware of the printing engine and/or other particular hardware and/or software used by the printer when printing the test pattern. The test patterns are each associated with a type of printer, such as for compatibility with a particular model or make of printer, and/or a particular set of firmware used by the printer. In one embodiment, the test pattern may not be configured to be compatible with the printer device 14 it is meant to print on and may need to undergo a conversion process for ensuring compatibility. The conversion may be performed at the service provider side 110, e.g., by the service desk 112 via its workstation or the service desk engine 114, or on the client side 10, e.g., by client device manager 16 or the user 12 via his workstation.

The rules stored in the IQ database 120 include logic and/or instructions to be applied to image quality analysis performed by the AIQD engine for correlating a defect detected in an image to a defect in a physical component of the printer that printed the image. Furthermore, the rules may correlate possible defects in the physical components of the printer with an action item, such as a recommendation in how to fix the defective components and what parts need to ordered. The rules are stored as sets of rules, with each set of rules designed for a particular printer for making determinations based on the particular hardware of the printing engine and/or other particular hardware and/or software used by the printer when printing the test pattern. The sets of rules are each associated with a type of printer, such as a particular model or make of printer, and/or a particular set of firmware used by the printer.

Each set of rules includes a series of rules to run against a particular test pattern, with each rule including instructions and logic describing the rule so that the rule is executable. The rules typically include a test to be applied to the image of the printed test pattern and pass or fail metrics based on boundary conditions such as a threshold range for some attribute. For example, a rule might includes instructions for measuring image skew on the image of the printed test pattern and for comparing to the expected skew for the particular test pattern file.

The rule would also contain a tolerance range for the image skew and logic to determine if the skew of the image of the printed test pattern was within the tolerance range or not, which would further determine if the image of the printed test pattern passed or failed on the rule. Rule failure indicates a defect in the image of the printed test pattern. As described further below, the rules and the boundary conditions provided with rules are configurable. Image attributes that the test patterns and the rules examine include image rotation, image skew, grey scale accuracy, line width, accuracy of frequency patterns in the image (which may be an indicator of component failure). The rules further correlate the defect in the image of the printed test pattern to possible defects in the physical components of the printer. Additionally, the rules correlate defects in the printer with respective action items.

The IQ database may further include historical data from which the AIQD rules configuration engine may make inferences. The historical data may include, for example, which test pattern was used and which rules were applied in association with a service incident report and feedback data indicating success in applying the rules

The service desk 112 includes a first communication device 124 for receiving the request 17 to file a service incident report from the client side 10, a second communication device 126 for communicating with the service desk engine 114. The request 17 may be received in a variety of forms, such as in the form of a phone call, electrical signal (analog or digital), or an email. The service desk 112 is provided with a workstation including a processor 128 for receiving information included in the request 17 received from the client side 10 and generating the service incident report. The workstation may include UI 130 for entering information into the processor, and a display device for displaying information to the operator. The first and/or the second communication devices 124 and 126 may be integrated with the workstation. It is also possible that the first and second communication devices 124 and 126 are configured as a single communication device. The first communication device 124 may be a telephone or a data communication device that is in data communication with the printer device 14 or the client device manager 16 via a communication medium (not shown), such as is known in the art for wired or wireless communication, e.g., via a network, such as an intranet or the Internet.

The service incident report is a message indicating that an incident has occurred with a printer device 14, e.g., that the printer device 14 output a defective image, and includes the ID code of the printer device 14. It may further include a cursory description of the problem associated with the incident that is being reported.

In one embodiment the user 12 requests generation of a service incident report by placing a telephone call to the first communication device 124 (which in this example is a telephone). The operator of the service desk 112 answers the telephone and enters the information corresponding to the request 17 into the processor 128 via the UI 130. The information corresponding to the request 17 indicates that an incident is being reported in connection with a printer device 14 and includes the ID code of the printer device 14, and may further include the description of the problem. The operator may be provided with a GUI displayed on the display device 132, such as an entry form with entry areas for entering information associated with the incident being reported. The GUI may provide the operator with a menu (e.g., a drop-down menu) of problem descriptions to select from. Once the operator has entered the information to be included in the service incident report, the service incident report is generated by the processor 128 and transmitted as a digital message via the second communication device 126 to the service desk engine 114.

In another method of initiating generation of a service incident report in accordance with another embodiment of the IQD system 100, the input device 20 associated with the printer device 14 is actuated by user 12, which causes the printer device 14 to generate a digital message that includes the printer device's 14 ID code, and to transmit the service incident report to the service provider side 110. The message is received by the service desk 124 as a request to transmit a service incident report. The service desk 124 formats the information included in the message into a service incident report and transmits the service incident report to the service desk engine 114.

Alternatively, the message may already be formatted properly as a service incident report and may be transmitted by the printer device 14 to the service desk engine 114 without involvement by the service desk 124. In this embodiment the service desk 124 may be omitted from the IQD system 100 or only used for handling service incident reports associated with printers that do not have the input device 20 or the capability of transmitting the service incident report digitally to the service desk engine 114. In this embodiment the printer device 14 communicates with the service desk engine 114, such as via the communication module 22 and the Internet, without involving the client device manager 16 in the communication.

In still another method of initiating generation of a service incident report in accordance with another embodiment of the IQD system 100 in which the service desk 124 may not be needed, the client device manager 16 is notified about the incident and generates a digital service incident report that includes the ID code of the printer 14 that is malfunctioning and possibly the nature of the problem being reported. The client device manager 16 is notified about the incident either via the printer device 14 that is malfunctioning, such as in response to actuation of the input device 20, or via notification from the user 12 by means of another processor, such as a workstation operated by the user 12. The workstation may execute a software module including a series of programmable instructions that provides the user 12 with a GUI for entering a request 17 to submit a service incident report, where the request 17 includes the printer device ID and may include a brief description of the problem, e.g., via a menu of selections. The software module arranges for the request 17, once entered, to be transmitted to the client device manager 16.

The client device manager 16 transmits the request 17 to the service provider side 110. The request 17 may be received by the service desk 124 which generates the service incident report and transmits it to the service desk engine 114. Alternatively, the request 17 may already be formatted properly as service incident report and may be transmitted by the client device manager 16 to the service desk engine 114, without any involvement by the service desk 124. The formatting of the request 17 into a proper service incident report may have been performed at the workstation operated by the user 12 or by the client device manager 16.

Upon receipt of the service incident report the service desk engine 114 accesses the test pattern database 116, retrieves an appropriate test pattern based on the printer device ID code included in the service incident report from the test pattern database 116 and the description of the problem (if included), and electronically transmits the retrieved test pattern as a printer ready data file to the client side 10. The service desk engine 114 uses the printer device ID to determine the make and model of the printer device 14 associated with the service incident report. This may be done by accessing a local or remote database that associates the printer device ID to the make and model of the associated printer device.

In one embodiment, the retrieved test pattern is transmitted as a data file to the printer device 14 via the client device manager 16. From the printer device's 14 perspective the received test pattern is a print job and upon receipt of the test pattern the printer device 14 prints the test pattern.

In another embodiment, the test pattern is transmitted by the service desk engine 114 to the printer device 14 without involvement of the client device manager 16, such as via the Internet in conjunction with the printer device's 14 communication module 22. In this embodiment the transmitting of the test pattern to the printer device 14 by the service desk engine 114 is performed in a single transmission operation, which means that the service desk engine 114 initiates the transmission via the Internet, and the printer device 14 receives the test pattern via the Internet and via the same transmission. In other words, the address destination of the Internet transmission of the test pattern by the service desk engine 114 is the printer device 14.

Alternatively, the test pattern is transmitted to the client device manager 16, which in turn transmits the test pattern to the appropriate printer device 14. The test pattern transmission to the client device manager 16 includes the ID code for the printer device 14 in order that the client device manager 16 can route the test pattern to the appropriate printer device 14.

The printer device 14 prints the test pattern and outputs a printed test pattern. The printed test pattern is scanned in and the corresponding image is transmitted back to the service provider side 110 for analysis by the AIQD engine 118. Transmission of the image corresponding to the scanned test pattern printout may be directly from the printer device 14 to the AIQD engine 118 or may be via the client device manager 16 and/or the service desk engine 114.

The process of scanning the printed test pattern and transmitting it to the service provider side 110 may be performed entirely by the printer device 14 with or without user intervention. For example, if the printer device 14 is provided with scanner device 24 and transport device 26, the printed test pattern is printed by the printer device 14, transported to the scanner device 24 by the transport device 26, scanned in by the scanner device 24, and the data generated by the scanner device 24 (herein referred to as the scanned test pattern) is transmitted to the service provider side 110 or the client device manager 16 via communication module 22, e.g., via the Internet as an attachment to an email transmitted to the service desk engine 114 or the AIQD engine 118. In the absence of a transport device 26, a user physically transports the printed test pattern to the scanner device 24 or a remote scanner device if the printer device 14 does not include scanner device 24. The user may actuate transmission of the scanned test pattern to the service provider side 110 or to the client device manager 16 via communication module 22, such as by entering a user command via UI 32 and/or GUI 34.

Transmission of the scanned test pattern may be automatic upon completion of the scan operation without any user intervention. When the scanned test pattern is transmitted to the client device manager 16, the client device manager 16 it transmits the scanned test pattern to the service provider side 110. When the scanned test pattern is transmitted by the printer device 14 to the service provider side 110 (e.g., the service desk engine 114 or the AIQD engine 118) the service provider side 110 receives the scanned test pattern via the Internet from the printer device 14 by a single transmission operation, which means that the printer device 14 initiates the transmission via the Internet, and the service provider side 110 receives the test pattern via the Internet and via the same transmission. In other words, the address destination of the Internet transmission of the scanned test pattern by the printer device 14 is the service desk engine 114 or the AIQD engine 118.

If the printer device 14 does not have the capability of communicating with client device manager 16 or the service provider side 110, the scanned test pattern may be stored on a computer readable storage device and retrieved by any processing device having communication capability which can transmit the scanned test pattern to the service provider side 110. The transmission by any device of the scanned test pattern to the service provider side 110 includes the scanned test pattern and an identification of the service incident report and printer device 14 it is associated with.

Where the printer device 14 is capable of digitally communicating with the service provider side 110 a diagnostic routine may be initiated at regular intervals, even when service incident report is not generated. The diagnostic routine may be automatically initiated by the client side 10 or the service provider side 110. The printer device 14 or the client device manager 16 may initiate the diagnostic routine by requesting a test pattern, or the service desk engine 114 may initiate the diagnostic routine by transmitting an appropriate test pattern retrieved from the IQ database 120. The rest of the diagnostic routine may proceed automatically or with user intervention, as described below. By providing diagnostics at regular intervals an image quality problem may be detected and diagnosed before the problem becomes noticeable to a user and the printed output significantly degraded.

The IQ database 120 stores a collection of rules for analyzing images, such as the scanned test patterns, in order to find defects in the images. Additionally, the rules may help to determine possible causes of the defects. The rules stored by the IQ database 120 are continually updated or reconfiured by the AIQD rules configuration engine 122 as more knowledge becomes available. The knowledge may be knowledge that becomes available about defects in printer devices, and particularly in specific makes and models of printer devices. For example, the knowledge may become available through studying the specific printer devices and their printed test patterns, simulating or experimentally causing defects in the printer devices and studying the resulting printed test patterns, and studying trends in image quality failures associated with specific printer devices based on analysis of historical image quality analysis results.

The image quality analysis detects defects in the image, if any, correlates each detected image defect with one or more defects in the software and/or hardware of the associated printer device, and recommends a solution for remedying each correlated printer device defect. The recommended solution is used to generate an action item 123. The action item 123 may be communicated to the client side 10. The rules and/or recommended action items 123 may have associated strengths. As knowledge becomes available as to the success in applying the rules to correlate the image defects to printer hardware and/or software defects, the rules and/or the strength of the rule may be adjusted accordingly. Furthermore, as knowledge becomes available as to success or lack thereof with respect to applying the recommended action items 123, the rules and/or the strength of the rules is adjusted accordingly.

The action item 123 is used to arrange for the defect to be remedied, which may include recommendations for ordering a technician to be dispatched with instructions of what to do to repair the printer device, and may further include recommendations for ordering any parts that may be needed for repairing the printer device. The action item 123 may be transmitted to the service desk 124 to allow the operator to order the necessary parts and to schedule and dispatch the technician with the instructions generated with the action item 123. The action item 123 may alternatively be provided to a processor which executes a software module including a series of programmable instructions. The processor may generate a request for the parts that need to be ordered, and further generate a request for a technician who has the necessary expertise (in accordance with the generated instructions) and is located in the region that the associated printer device is located in. The processor can be programmed to submit the order to the parts manufacturer with directions for delivery of the parts to a proper location. The processor can further be programmed to schedule a technician and inform the technician as to the schedule and the task that needs to be performed, including the instructions generated in the action item 123.

After an image quality analysis is performed on a scanned test pattern the results are stored in the IQ database 120. Accordingly, the IQ database 120 and/or the AIQD rules configuration engine 122 is updated with the results of the image quality analysis performed by the AIQD engine 118. Accordingly, the AIQD engine 118 may store the results in the IQ database 120 or communicate the results of its analysis to the AIQD rules configuration engine 122 which will in turn store the information in the IQ database 120. Since the rules stored in the IQ database are based on patterns recognized that indicate relationships between particular printers, defects and possible solutions, the detection of a defect and the determination of a solution are data that the AIQD rules configuration engine 122 can be used to establish new patterns and to generate new rules or update the rules and/or the associated strengths stored in the IQ database 120.

Furthermore, feedback related to implementation of the action item and the success or lack thereof of is communicated to the AIQD rules configuration engine for updating the rules or increasing the strength of the rules. After implementing the action item, in one embodiment, the user 12 reports the outcome (e.g., if the printer device 14 is successfully repaired or if the printer device 14 is still printing defective images) to the service desk 112 which provides the information to the AIQD rules configuration engine 122. The test pattern may be reprinted by the printer device (either the test pattern was stored by the printer device 14 or resent by the service desk engine 114) and sent to the service provider side 110 for reanalysis to confirm that the outcome reported by the user 12.

In another embodiment, user 12 informs the service provider side 110 (e.g., by actuating input device 20 on the printer device 14) that the action item was implemented, after which the test pattern is automatically reprinted by printer device 14 (either the test pattern was stored by the printer device 14 or it is resent by the service desk engine 114), the printed test pattern is scanned (either automatically, using the scanner device 24 and the transport device 26 or via intervention by user 12), and the scanned test pattern is provided to the AIQD engine 118 for analysis (either by the printer device 14, automatically or with user intervention, or by user intervention using another processor to transmit the scanned test pattern). The AIQD engine 118 determines if the printer device 14 was properly repaired, provides the knowledge to the AIQD rules configuration engine 122 for updating the rules and/or their strengths, and recommends an additional action item if repairs are still necessary.

Each software module described above includes a series of programmable instructions capable of being executed by the associated processor. The series of programmable instructions can be stored on a computer-readable medium, such as RAM, a hard drive, CD, smart card, 3.5″ diskette, etc., or transmitted via propagated signals for being executed by the associated processor for performing the functions disclosed herein and to achieve a technical effect in accordance with the disclosure. The functions of the respective software modules may be combined into one module or distributed among a different combination of modules.

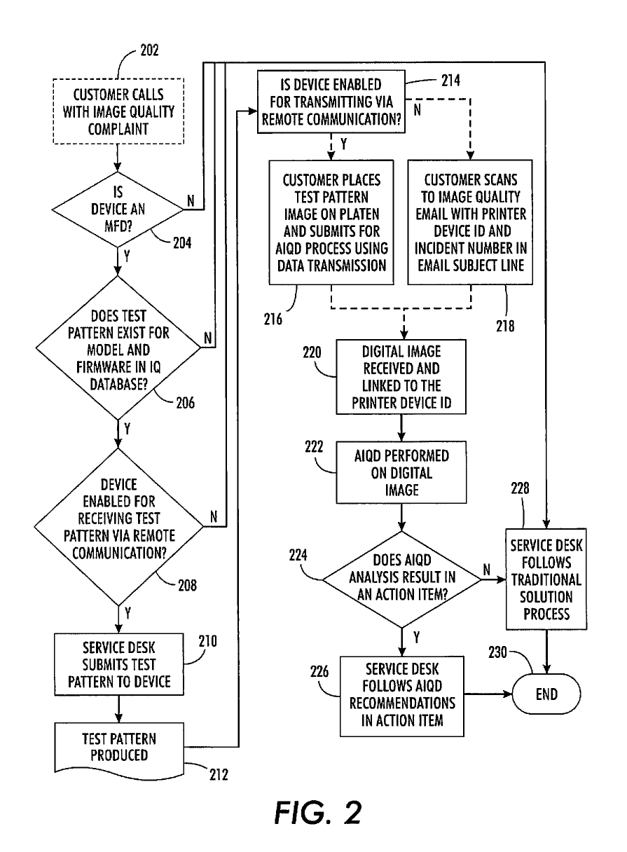

Referring to FIG. 2, a method of performing a diagnostic procedure when initiated by user 12 is shown. At step 202, a customer, e.g., user 12, calls with a complaint about quality of a printed image output by printer device 14 and provides the printer ID of printer device 14. At decision step 204, the printer ID is used to determine if the printer device 14 is an MFD. This can be done by looking up information about the printer device 14 using the printer ID on a local or remote database. If so, control passes to step 206, and if not, control passes to step 228. Alternatively, control could pass to step 218 in which a scanner that is not included with the printer device 14 is used to capture an image of the printed test pattern. At decision step 206, the printer ID is used to determine if a test pattern is stored in test pattern database 116 for the make and model and firmware of the printer device 14. If so, step 208 is executed. If not, step 228 is executed. At decision step 208, the printer ID is used to determine if printer 14 is remote communication enabled, e.g., for receiving the test pattern from the service desk 112. If so, (e.g., the printer device 14 can receive the test pattern via a communication link (e.g., via a network, such as the Internet) with the service desk 112, or via the client device manager 16 which received it from the service desk 112) control passes to step 210, and if not, control passes to step 228. At step 210, the service desk 112 submits the test pattern to the printer device 14. At step 212, the printer device 14 prints the test pattern. At decision step 214, the printer ID is used to determine if the printer device 14 has an interface for communicating with the service provider side 110, e.g., via the Internet. If so, control passes to step 216, and if not, control passes to step 218. At step 216, the printed test pattern is scanned in by the printer device 14 and the scanned test pattern is sent via the communication interface to the service provider side 110. The communication sent via the communication interface includes the printer ID for printer device 14 and an ID that is associated with the incident being reported for service, herein referred to as an incident ID. The scanning may be performed by placing the printed test pattern on the platen of the scanner device that is integrated with the printer device 14, where the placing is performed by the user 12 or the transport device 26, if available. The scanned test pattern may be sent over the Internet, such as via an email sent from the printer device 14 to the service desk 112 or to the service desk engine 114. The image of the printed test image may be included in the body of the email or provided as an attachment to the email The printer ID and incident ID may included in the body of the email or in the subject field of the email At step 218, the user 12 may scan the printed test pattern, either using the scanner device 24 integrated with the printer device 14 or using a remote scanner device. The output from the scanner device is transmitted by the user 12, e.g., as an attachment to an email sent via the Internet. The email must specify, e.g., in the subject line, the printer ID and the incident ID.

At step 220, the scanned test pattern transmitted in step 216 or 218 is received by the service provider side 110 (e.g., the service desk 112 or the service desk engine 114). At step 222, the AIQD engine 118 uses the printer ID to look up rules in the IQ database 122 to apply to the image of the scanned test pattern for analyzing the image. At decision step 224, a determination is made if the analysis performed in step 224 resulted in generation of an action item including an alert or a recommendation. An alert may include a message indicating a defect in the image of the printed test pattern, such as that its skew is outside of the tolerance threshold range, that grayscale or color measurements associated with the image are out of a selected tolerance threshold range, or that objects in the image are not located in correct positions when measured against the test pattern. The recommendations generated may include a recommendation to order a part or a recommendation to dispatch a technician to service the printer in accordance with specific instructions. If the determination at step 224 is positive, then step 226 is executed, otherwise, step 228 is executed. At step 226, the service desk 112 follows the recommendations, such as by ordering the part and scheduling and dispatching the technician with the specific instructions. Next, at step 230, the diagnostic procedure is completed and terminated. At step 228, the service desk 112 follows a traditional process by recording user's description of the problem and dispatching a technician to evaluate the problem, after which the diagnostic procedure ends at step 230. Step 228 is reached when the method of supplying the test pattern to the printer device 14 and analyzing the scanned test pattern is not possible or successful.

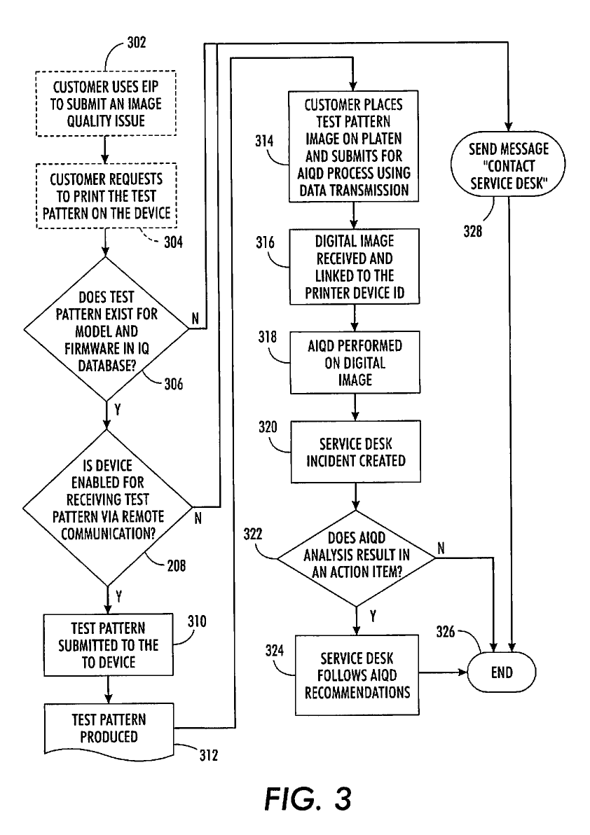

With reference to FIG. 3, a method of performing a diagnostic procedure when initiated by the printer device 14 or the client device manager 16 is shown. At step 302, the user 12 initiates a diagnostic procedure, such as via UI 32 of the printer device 14. The procedure may also be initiated by the printer device 14 itself, such as in response to a trigger such as an event or the occurrence of completion of a time interval (e.g., where a diagnostic procedure is performed at regular time intervals). The procedure may also be initiated by the service provider side 110 in response to a similar trigger, where the service provider side 110 sends a message to the printer device 14 to begin the diagnostic procedure. At step 304, the service incident report is transmitted by the printer device 14 via communication module 22 to the service desk engine 114. At decision step 306, the printer ID is used to determine if a test pattern is stored in test pattern database 116 for the make and model and firmware of the printer device 14. If so, step 308 is executed. If not, step 328 is executed.

At decision step 308, the printer ID is used to determine if printer 14 is remote control enabled, e.g., for receiving the test pattern from the service desk 112. If so, (e.g., the printer device 14 can receive the test pattern via a communication link with the service desk 112, or via the client device manager 16 which received it from the service desk 112) control passes to step 310, and if not, control passes to step 328. At step 310, the service desk engine 114 submits the test pattern to the printer device 14 via the printer device's 14 communication module 22. At step 312, the printer device 14 prints the test pattern. At step 314, the printed test pattern is scanned in by the printer device 14 and the scanned test pattern is sent via the communication interface to the service provider side 110. The communication sent via the communication interface includes the printer ID for printer device 14 and the incident ID. The scanning may be performed by placing the printed test pattern on the platen of the scanner device that is integrated with the printer device 14, where the placing is performed by the user 12 or the transport device 26, if available. The scanned test pattern is sent over the Internet, such as an attachment to an email sent from the printer device 14 to the service desk engine 114.

At step 316, the scanned test pattern transmitted in step 314 is received by the service provider side 110 (e.g., the service desk engine 114). At step 318, the AIQD engine 118 uses the printer ID to look up rules in the IQ database 122 to apply to the image of the scanned test pattern for analyzing the image. At step 320, a service desk incident is created which includes a link to the image of the printed test image, and a link to the printer device 14 which caused the incident and information related to the incident, such as tracking information about any supplies ordered or technicians dispatched, comparison of the tracked information to contracted response and resolution time criteria. At decision step 322, a determination is made if the analysis performed in step 318 resulted in generation of an alert or a recommendation. The alert describes one or more defects detected in the image of the printed test pattern. The recommendations generated may include a recommendation to order a part or a recommendation to dispatch a technician to service the printer in accordance with specific instructions.

If the determination at step 322 is positive, then step 324 is executed, otherwise, step 326 is executed in which the diagnostic procedure is completed and terminated. At step 324, the service desk 112 follows the recommendations, such as by ordering the part and scheduling and dispatching the technician with the specific instructions. Next, at step 326, the diagnostic procedure is completed and terminated. At step 328, the service desk engine 114 returns a message to the printer device 14 that the diagnostic procedure was unsuccessful since communication between the service desk engine 114 and the printer device 14 failed. The message recommends that service desk 112 be contacted.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An image quality diagnostic system for diagnosing an image, the system comprising:
at least one processor device communicating with a network for executing a series of programmable instructions for performing the method of:
receiving via the network from a remote node of the network a service incident report including an indication of a type of a printer device, the printer device being disposed along the network at a location remote from the at least one processor device;
accessing a storage device storing a collection of test patterns;
electronically selecting a test pattern from the collection of test patterns based on the type of the printer device, wherein the test pattern is configured as input that the printer device can receive and output corresponding printed output; and
transmitting the selected test pattern via the network for the selected test pattern to be provided as input to the printer device.

2. The image quality diagnostic system in accordance with claim 1, wherein the method performed in accordance with execution of the series of software instructions by the at least one processor device further comprises:
receiving via the network an image of printed output, wherein the printed output corresponds to the selected test pattern; and
electronically analyzing the image for detecting a defect in the image.

3. The image quality diagnostic system in accordance with claim 2, wherein the method performed in accordance with execution of the series of software instructions by the at least one processor device further comprises:
electronically generating at least one recommendation for servicing the printer device based on the detected defect; and
outputting the at least one recommendation.

4. The image quality diagnostic system in accordance with claim 2, wherein the analyzing includes selecting a set of at least one rule from a plurality of rules based on at least one of the type of the printer device, and the test pattern that was selected, and applying the selected set of at least one rule.

5. The image quality diagnostic system in accordance with claim 4, wherein respective rules of the plurality of rules are associated with a type of printer device and are configured to detect a defect in the image and correlate the detected defect to a defect in a printer device of the type of printer device associated with the rule.

6. The image quality diagnostic system in accordance with claim 4,
wherein the method performed in accordance with execution of the series of software instructions by the at least one processor device further comprises:
electronically generating at least one recommendation for servicing the printer device based on the detected defect;
receiving feedback information related to improvement in printed output corresponding to the selected test pattern output by the printer device after implementing the at least one recommendation; and
updating the plurality of rules with the feedback information.

7. The image quality diagnostic system in accordance with claim 3, wherein the at least one recommendation includes recommending at least one of instructions to be performed by a technician and ordering at least one part.

8. The image quality diagnostic system in accordance with claim 1, wherein the network is the Internet, and the transmitting the test pattern includes transmitting the test pattern digitally to the printer device via the network by a single transmission operation.

9. The image quality diagnostic system in accordance with claim 2, wherein the network is the Internet, and the receiving the image of the printed output includes receiving the image of the printed output from the printer device via the network by a single transmission operation.

10. An image quality diagnostic system for diagnosing an image, the system comprising:
at least one processor device communicating with a network for executing a series of programmable instructions for performing the method of:
receiving via the network from a remote node of the network an image of printed output output by a printer device, wherein the printed output corresponds to an input test pattern;
electronically selecting a set of at least one rule from a plurality of rules based on a type of the printer device;
electronically analyzing the image for detecting a defect in the image by applying the selected set of at least one rule;
electronically generating at least one recommendation for servicing the printer device based on the detected defect by applying the selected set of at least one rule; and
outputting the at least one recommendation.

11. The image quality diagnostic system in accordance with claim 10, wherein respective rules of the plurality of rules are associated with a type of printer device and are configured to detect a defect in the image and correlate the detected defect to a defect in a printer device of the type of printer device associated with the rule.

12. The image quality diagnostic system in accordance with claim 10, wherein the method performed in accordance with execution of the series of software instructions by the at least one processor device further comprises:
receiving feedback information related to improvement in printed output corresponding to the selected test pattern output by the printer device after implementing the at least one recommendation; and
updating the plurality of rules with the feedback information.

13. The image quality diagnostic system in accordance with claim 10, wherein the at least one recommendation includes recommending at least one of instructions to be performed by a technician and ordering at least one part.

14. The image quality diagnostic system in accordance with claim 10, wherein the network is the Internet, and the receiving the image of the printed output includes receiving the image of the printed output from the printer device via the network by a single transmission operation.

15. A method for diagnosing image quality comprising:
receiving by a processor, via a network from a remote node of the network, a service incident report including an indication of a type of the printer device the printer device being disposed along the network at a location remote from the processor;
accessing by the processor a storage device storing a collection of test patterns;
selecting by the processor a test pattern from the collection of test patterns based on the type of the printer device, wherein the test pattern is configured as input that the printer device can receive and output corresponding printed output; and
transmitting by the processor the selected test pattern for the selected test pattern to be provided as input to the printer device.

16. The method in accordance with claim 15, comprising:
receiving via the network by the processor an image of printed output, wherein the printed output corresponds to the selected test pattern; and
analyzing by the processor the image for detecting a defect in the image.

17. The method in accordance with claim 16, comprising:
generating at least one recommendation by the processor for servicing the printer device based on the detected defect; and
outputting by the processor the at least one recommendation.

18. The method in accordance with claim 17, wherein the at least one recommendation includes recommending at least one of instructions to be performed by a technician and ordering at least one part.

19. The method in accordance with claim 15, wherein the network is the Internet, and the transmitting the test pattern includes transmitting the test pattern digitally to the printer device via the network by a single transmission operation.

20. The method in accordance with claim 16, wherein the network is the Internet, and the receiving the image of the printed output includes receiving the image of the printed output from the printer device via the network by a single transmission operation.

21. A computer-readable medium storing a series of programmable instructions configured for execution by at least one processor for performing a method for diagnosing image quality, the method comprising the steps of:
receiving a service incident report including an indication of a type of a printer device;
accessing a storage device storing a collection of test patterns;
selecting a test pattern from the collection of test patterns based on the type of the printer device, wherein the test pattern is configured as input that the printer device can receive and output corresponding printed output;
transmitting the selected test pattern for the selected test pattern to be provided as input to the printer device;
receiving an image of printed output, wherein the printed output corresponds to the selected test pattern;
analyzing the image for detecting a defect in the image;
generating at least one recommendation for servicing the printer device based on the detected defect; and
outputting the at least one recommendation.

22. The computer-readable medium in accordance with claim 21, wherein the at least one recommendation includes recommending at least one of instructions to be performed by a technician and ordering at least one part.
